(19) United States
(12) Patent Application Publication
(10) Pub. No.: US 2006/0021462 A1
(43) Pub. Date: Feb. 2, 2006

(54) Shift lever with switch for vehicular automatic transmission

(75) Inventor: Norihito Shioji, Shizuoka (JP)

Correspondence Address: FOLEY AND LARDNER LLP;SUITE 500, 3000 K STREET NW, WASHINGTON, DC, 20007, US

(73) Assignee: FUJI KIKO CO., LTD.

(21) Appl. No.: 11/180,656

(22) Filed: Jul. 14, 2005

(30) Foreign Application Priority Data
Jul. 29, 2004 (JP) 2004-221069

(51) Int. Cl. B60K 20/02

(52) U.S. Cl. 74/543

(57) ABSTRACT

In a shift lever for an automatic transmission, a shift lever main body is penetrated through a slide plate and including a knob cover penetrated through the slide plate, the knob cover including a socket portion exposed to an outside of the knob cover, and a knob onto which at least one wire terminal is attached, the wire terminal being engaged with the socket portion and being exposed to an outside thereof, is attached onto the shift lever main body to cover the socket portion of the knob cover.

### BACKGROUND OF THE INVENTION

1. Field of the Invention

The present invention relates to an assembly structure of a shift knob of a shift lever of an automatic transmission to be assembled onto an instrument panel of an automotive vehicle or a center console thereof.

2. Description of the Related Art

A Japanese Patent Application First Publication No. 2002-301949 published on Oct. 15, 2002 exemplifies a previously proposed shift lever for the vehicular automatic transmission. This previously proposed shift lever includes: a shift knob having a knob cover inserted into a shift lever main body constituted by a pipe having a predetermined length; and a knob integrally molded with the knob cover and mounted on a top portion of the shift lever. A knob button is installed on the knob. In addition, the knob cover penetrates a slide plate inside of the indicator and extended to a lever base portion. An O/D (overdrive) switch is installed on a part of knob cover located in the vicinity to the knob. A harness of the knob cover is extended along the knob cover and is exposed to its lower end portion of knob cover. A terminal of the harness is inserted into its socket portion installed on the lever base portion to make an electrical conduction with a predetermined electric equipment.

### SUMMARY OF THE INVENTION

In the previously proposed shift lever described above, terminals of a harness connected to the O/D switch are inserted into a socket portion of a lever base portion located at a lower side of the slide plate which is an inside of the indicator. When assembling the shift lever, a knob cover is inserted into the shift lever main body constituted by the pipe through its upper portion and a lower end portion of the knob cover is fitted into a gap hole of an outer peripheral portion of the shift lever main body of a slide plate through which the shift lever is already penetrated. Thereafter, the terminals of the harness is needed to be inserted into the socket portion. Hence, at this time, since the gap hole of the outer peripheral portion of the shift lever main body cannot visually be recognized, the lower end portion of the knob cover is satisfactorily fitted into the gap hole so that the slide plate would be damaged. Hence, an accuracy of an assembly of the shift lever onto the automotive vehicle is reduced.

It is, therefore, an object of the present invention to provide an improved shift lever of an automatic transmission which is highly accurate in its assembly and is simple in construction.

According to one aspect of the present invention, there is provided a shift lever for an automatic transmission, comprising: a shift lever main body penetrated through a slide plate and including a knob cover penetrated through the slide plate, the knob cover including a socket portion exposed to an outside of the knob cover; and a knob onto which at least one wire terminal is attached, the wire terminal being engaged with the socket portion and being exposed to an outside thereof, and attached onto the shift lever main body to cover the socket portion of the knob cover.

According to another aspect of the present invention, there is provided a method applicable to a shift lever for an automatic transmission, comprising: providing a shift lever main body penetrated through a slide plate and including a knob cover penetrated through the slide plate, the knob cover including a socket portion exposed to an outside of the knob cover; and providing a knob onto which at least one wire terminal is attached, the wire terminal being engaged with the socket portion and being exposed to an outside thereof, and attached onto the shift lever main body to cover the socket portion of the knob cover.

This summary of the invention does not necessarily describe all necessary features so that the invention may also be a sub-combination of these described features.

### BRIEF DESCRIPTION OF THE DRAWINGS

FIG. 1 is a perspective view of a shift lever of a preferred embodiment according to the present invention.

FIG. 2 is a longitudinally cross sectioned view of the shift lever shown in FIG. 1.

FIG. 3 is a longitudinally cross sectioned view of an essential part of the shift lever shown in FIG. 1.

FIG. 4 is a partially omitted perspective view of the shift lever in the preferred embodiment according to the present invention.

### DETAILED DESCRIPTION OF THE PREFERRED EMBODIMENT

Reference will hereinafter be made to the drawings in order to facilitate a better understanding of the present invention.

An assembly structure of a shift knob of a shift lever in a preferred embodiment according to the present invention is such that a knob cover having a socket portion exposed to an upper end portion is separated from a knob having at least one terminal engaged with the socket portion and projected from a lever end surface of the wire terminal.

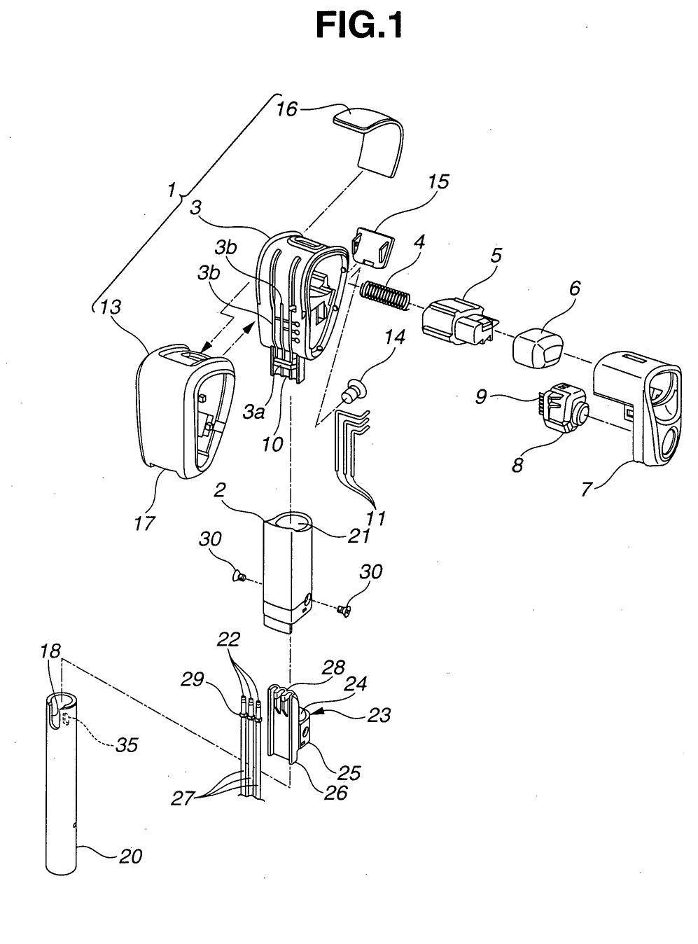

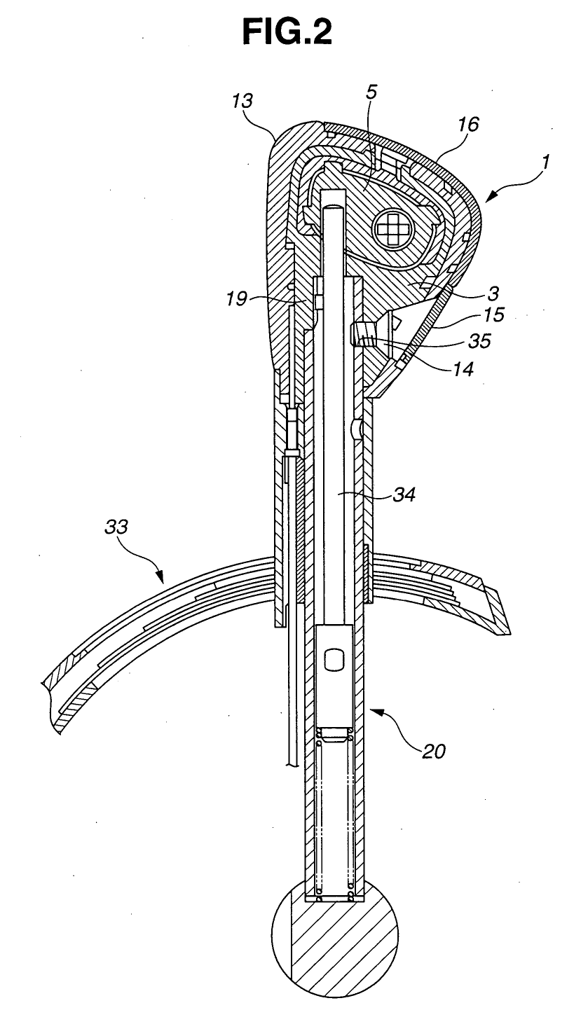

FIGS. 1 through 3 show a preferred embodiment of the shift lever for an automatic transmission according to the present invention. FIG. 1 is an exploded perspective view of the shift lever in the preferred embodiment according to the present invention. As shown in FIG. 1, knob 1 is separated from knob cover 2. That is to say, knob 1 includes a frame 3 constituted by a rigid resin. A spring 4, a knob button 5, and a button cap 6 are inserted into a cavity portion whose one side is closed. A finisher 7 is closed with the other side of frame 3. In this finisher 7, a switch 8 is assembled for switching the O/D (overdrive). Terminals 9 of this switch 8 are fixed along a vertical direction of this switch 8, as shown in FIG. 1. Terminals 9 of this switch 8 are connected to wire terminals 11 fixed on frame 3 by inserting these wire terminals 11 into holes formed with a rib 3a of an engagement convex portion 10 integrally formed on a lower portion of frame 3. These holes are linked with grooves 3b formed on an outer surface of frame 3. The assembly of wire terminals 11 onto frame 9 may be carried out by inserting wire terminals 11 into grooves formed with rib 3a (rib 3a is formed in a multi-groove shape) from above and may be fixed by molding a skin body 13 as will be described later.

Skin body 13 formed of a rubber or a soft resin is attached onto the outer surface of frame 3. Hence, wire terminals 11 are firmly fixed onto frame 3 by grasping it with both of frame 3 and skin body 13. A lower end portion of each wire terminal 11 is a free end. A maintenance hatch 15 made of a rigid resin or so forth is attached onto a front end side of skin body 13 to hide a head portion of a knob fixing screw 14 to be screwed onto shift lever main body 20. In addition, a panel 16 made of the rigid resin or so forth is attached onto an upper surface of skin body 13.

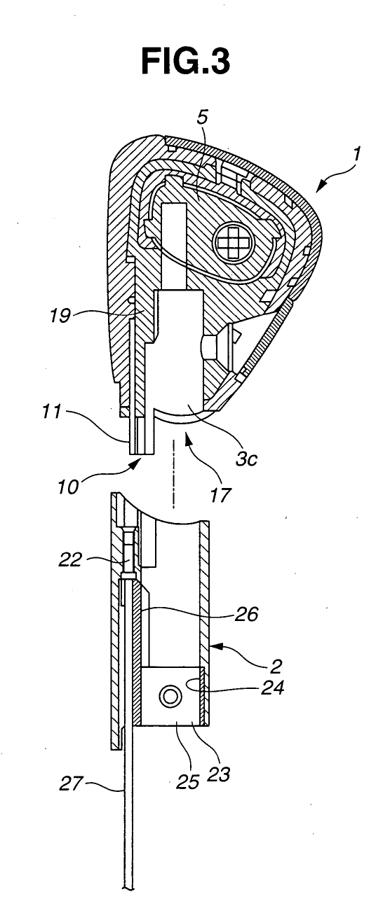

It is noted that an opening 17 is formed on a lower surface of skin body 13 and an engagement convex portion 10 is projected from opening 17. This engagement convex portion 10 encloses a part of each wire terminal 11 which is projected from the lower portion of frame 3 and prevents wire terminals 11 from being deformed. An opposite side of a part of engagement convex portion 10 enclosing wire terminals 11 is formed in an arc shape. When the engagement convex portion 10 is fitted to knob cover 2, engagement convex portion 10 serves to guide so that positions of each wire terminal 11 and of each socket 22 are mutually coincident with each other. As shown in FIG. 3, a hole 3c is formed on frame 3 to fit an upper end portion of shift lever main body 20 into by a predetermined length. A positioning convex portion 19 which is engaged with a cutout portion 18 formed on the upper end portion of shift lever main body 20 is formed on a bottom portion of hole 3c.

On the other hand, knob cover 2 is an exterior part made of a synthetic resin in a form of a cylindrical body and is provided with an axial hole 21 into which shift lever main body 20 formed with a pipe through which a compression rod 34 is inserted. An upper end surface of knob cover 2 is formed in a bend shape having a curvature which is the same as a lower surface of frame 3 to support stably the lower surface of knob 1. A harness lock plate 23 in which sockets 22 having a flexible harness (or cables) 27 are mounted is inserted into an inside of knob cover 2.

Harness lock plate 23 includes an annular body 25 having substantially the same cross sectional shape as the cross sectional shape of axial hole 21 and having a penetrated hole 24 through which shift lever main body 20 is inserted and a harness holding portion 26 located at a side portion of annular body 25, formed in a groove shape, and having a predetermined height. Annular body 25 is integrally formed with harness holding portion 26. Sockets 22 are held on harness holding portion 26 by fitting sockets 22 into fitting grooves 28 formed on harness holding portion 26 in, for example, three rows in a longitudinal direction as viewed from FIG. 1. A stopper portion 29 is formed on a lower portion of each socket 22 and an upper end portion of harness 27. This harness lock plate 23 is fixed onto shaft lever main body 20 together with knob cover 2 by means of screws 30, 30. This fixing method may be carried out by means of pawls other than screws or, alternatively, a press fit.

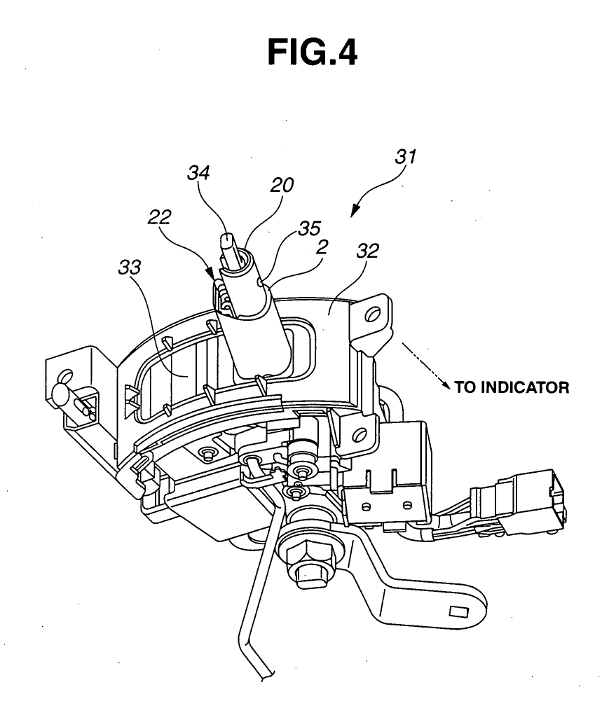

As shown in FIG. 4, shift lever 31 is shipped to an automotive vehicle manufacturing factory as a substantial finished product with knob 1 attached onto knob cover 2. Therefore, knob cover 2 is already attached onto shift lever main body 20 inserted through a slide plate 33 of a slid casing 32. Sockets 22 are exposed from the upper end surface of knob cover 2. Hence, sockets 22 can visually be recognized.

Hence, after shift lever 31 is assembled within the indicator of the vehicular instrument panel or the vehicular center console at the automotive vehicle manufacturing factory, knob 1 is attached onto the upper end portion of knob cover 2 projected from the indicator.

At this time, when engagement convex portion 10 of knob 1 is brought a face to face with harness holding portion 26 which can visually be recognized from the upper end surface of knob cover 2 and pressed down, the lower end portions of wire terminals 11 is fitted into sockets 22 so as to be electrically connected to each other and the lower surface of knob 1 is contacted with the bend surface of the upper end surface of knob cover 2. The upper end portion of shift lever main body 20 is inserted into hole 3c of knob 1. An upper end portion of compression rod 34 is contacted against an oblique surface portion formed on a knob button 5.

When knob fixing screw 14 is fixed onto screw hole 35 located at the upper end of shift lever main body 20 from frame 3 with maintenance hatch 15 opened, the assembly of shift lever 31 onto the indicator of the vehicular instrument panel or center console ended.

It is noted that knob button 5 is used to move compression rod 34 of shift lever main body 20 in a downward or biased position direction according to a presence or absence of a press operation of a button portion thereof.

The entire contents of a Japanese Patent Application No. 2004-221069 (filed in Japan on Jul. 29, 2004) are herein incorporated by reference. The scope of the invention is defined with reference to the following claims.

What is claimed is:

1. A shift lever for an automatic transmission, comprising:
a shift lever main body penetrated through a slide plate and including a knob cover penetrated through the slide plate, the knob cover including a socket portion exposed to an outside of the knob cover; and
a knob onto which at least one wire terminal is attached, the wire terminal being engaged with the socket portion and being exposed to an outside thereof, and attached onto the shift lever main body to cover the socket portion of the knob cover.

2. A shift lever for an automatic transmission as claimed in claim 1, wherein the knob cover is provided with an axial hole through which the shift lever main body is inserted and through which a harness lock plate to hold the socket portion is inserted and fixed thereto.

3. A shift lever for an automatic transmission as claimed in claim 1, wherein the socket portion is exposed to an upper direction with respect to the knob cover and a free end of the wire terminal is projected from the knob to engage with the socket portion of the knob cover.

4. A shift lever for an automatic transmission as claimed in claim 2, wherein the socket portion comprises a plurality of socket portions and the wire terminal comprises the same number wire terminals as the socket portions and the harness lock plate comprises an annular body arranged at an opposite side to fitting grooves for the respective socket portions via the harness holding portion and having a penetrating hole of the same cross sectional shape as that of the axial hole of the knob cover and through which the shift lever main body is penetrated.

5. A shift lever for an automatic transmission as claimed in claim 4, wherein the annular body is formed along a periphery of the axial hole of the knob cover.

6. A shift lever for an automatic transmission as claimed in claim 4, wherein stoppers are attached onto boundaries between respective socket portions and harness portions connected to the respective socket portions and onto the harness holding portion.

7. A shift lever for an automatic transmission as claimed in claim 1, wherein the knob comprises a frame having an engagement convex portion on which a plurality of holes formed on a rib and through which a plurality of wire terminals are inserted, the respective wire terminals having one ends connected to terminals of an Over-drive switch and having the other ends inserted into respective socket portions attached onto the fitting grooves of the harness holding portion.

8. A shift lever for an automatic transmission as claimed in claim 7, wherein the engagement recess portion is projected from an opening of a skin body of the knob when the respective wire terminals extended along respective grooves formed on the frame are inserted into the respective socket portions fitted into the respective fitting grooves.

9. A shift lever for an automatic transmission as claimed in claim 8, wherein the frame of the knob comprises a cavity portion, one side thereof being closed, into which a spring, a knob button to be engaged with a compression rod of the shift lever main body, and a button cap are inserted, the other side of the cavity portion being closed with a finisher.

10. A method applicable to a shift lever for an automatic transmission, comprising:
providing a shift lever main body penetrated through a slide plate and including a knob cover penetrated through the slide plate, the knob cover including a socket portion exposed to an outside of the knob cover; and
providing a knob onto which at least one wire terminal is attached, the wire terminal being engaged with the socket portion and being exposed to an outside thereof, and attached onto the shift lever main body to cover the socket portion of the knob cover.
